(19) United States
(12) Patent Application Publication
(10) Pub. No.: US 2014/0245037 A1
(43) Pub. Date: Aug. 28, 2014

(54) System and Method for Utilizing Standard Four Wire USB for Multiple Power Modes and Out of Band State Management

(71) Applicant: iKingdom Corp., Calgary (CA)

(72) Inventors: Michael Loh, Calgary (CA); Edmund Geeraert, Calgary (CA)

(73) Assignee: iKingdom Corp., Calgary (CA)

(21) Appl. No.: 14/188,657

(22) Filed: Feb. 24, 2014

Related U.S. Application Data
(60) Provisional application No. 61/767,909, filed on Feb. 22, 2013.

(51) Int. Cl. G06F 1/26

(52) U.S. Cl. CPC G06F 1/266
USPC 713/310

(57) ABSTRACT

A cable for establishing electronic communication between a first device and a second device is described. One end of the cable comprises a standard USB device connector that has four electrical contacts; two for power (VBUS, GND) and two for differential data signals (D+ and D−). The other end of the cable comprises a proprietary device connector having at least four corresponding electrical contacts and at least one additional electrical contact. The cable also has inline circuitry configured to control the power direction between the ends of the cable based on a characteristic of a signal originating from an electrical contact of the USB device connector. The devices and methods described herein enables reverse direction power across a standard 4 wire USB device receptacle in a non standard way while autonomously providing standard USB data connectivity.

This application claims the benefit of priority of U.S. provisional application Ser. No. of 61/767,909 filed on Feb. 22, 2013. This and all other referenced extrinsic materials are incorporated herein by reference in their entirety. Where a definition or use of a term in a reference that is incorporated by reference is inconsistent or contrary to the definition of that term provided herein, the definition of that term provided herein is deemed to be controlling.

### FIELD OF THE INVENTION

The field of the invention is electronic systems and methods, more specifically, devices and protocols for data and power transmission.

### BACKGROUND

The following description includes information that may be useful in understanding the present invention. It is not an admission that any of the information provided herein is prior art or relevant to the presently claimed invention, or that any publication specifically or implicitly referenced is prior art.

The Universal Serial Bus standard was developed in the 1990's to standardize communication and power supply hardware and protocols between different electronic devices. The USB standard (hereinafter “USB”) assumes a specific relationship between a master host (generally a computer) and a slave device (generally a peripheral device). The connection between host and device is with four wires: VBUS (power), Ground, D+ and D− (D+ and D− being differential data lines). Power is supplied from the host to the device across the VBUS line, and all data communications are sent across the differential data lines. The data communications are controlled by the master host.

With the evolution of computing devices, the market is seeing a new category consisting of handheld computing devices such as tablets and smartphones (e.g., iOS® devices like the iPad®, iPhone® and iPod touch® and Andriod® devices like the Samsung Galaxy®, HTC One®, Motorola Druid Razr®, and Kindle Fire®, to name a few). When these devices are connected to a computer via the computer's USB host receptacle (e.g., standard type A USB host port), the handheld computing device is the slave device (e.g., the handheld device is viewed as a peripheral device from the perspective of the computer). However, as the performance and capabilities of handheld computing devices improves, it is desirable to use these devices as the master host when connected to other peripheral devices (e.g., Speakers, Microphones, Headsets, Audio Interfaces, Synthesizers, Mixers, Effects and Converters). The handheld devices sometimes can optionally take power to charge or maintain the battery operated computing device or have other special operation state requirements that are not compliant with the four wire implementation of USB, requiring additional wires, specialized connectors, and/or limited functionality.

It would be advantageous to provide devices and protocols that address the problems above to better facilitate the use of handheld computing devices as master host across USB communication channels.

Thus, there is still a need for improved data and power transmission devices and methods.

### SUMMARY OF THE INVENTION

The inventive subject matter provides apparatus, systems and methods in which a cable comprises a standard USB device connector (e.g., standard type B USB connector or other standard USB peripheral device connector) at one end and a proprietary connector that encapsulates USB plus other signals at another end (e.g., an Apple® 30 pin dock connector, an Apple® Lightning connector, a PDMI connector, a Samsung® 30 pin connector). The standard USB device connector has four electrical contacts, two of which are designated as power lines (e.g., VBUS, GND) and two of which are designated as differential data signal lines (e.g., D+ and D−). In the case of USB 3.0 (“SuperSpeed”), the USB device connector has five additional electrical contacts (two additional different pairs and one additional ground). The proprietary connector also has at least four electrical contacts, two of which are designated as power lines (e.g., VBUS, GND) and two of which are designated as differential data signal lines (e.g., D+ and D−). The proprietary device connector also has a fifth electrical contact, designated as an additional power line (e.g.. Voltage in) and sixth through n^{th} electrical contacts, designated as additional data signaling lines.

As used herein, “designated” means the electrical contacts have been pre-identified and designed for a particular use (e.g., transmitting power, transmitting data, selecting state). “Designated” does not necessarily imply that an electrical contact is limited to only one use (e.g., an electrical contact may have non-designated uses and/or non-standard uses). As used herein, “proprietary connector” means a connector that is different than the USB standard in at least one aspect, whether functionally or physically (e.g., additional electrical contacts or non-standard uses of electrical lines such as sending 3.3V and 10 mA signals rather than 5 v and 100 mA/500 mA signals). For example, even though a mini-A connector, a micro-A connector, and a micro-B connector are generally thought of as standard USB device connectors, they could be considered a “proprietary connector” according to the definition above, if they are used in a non-standard manner. Moreover, “pproprietary connector” does not necessarily mean that the connector is owned by an entity or that it can only be sold, used, and/or manufactured by a particular entity (e.g. owner), unless expressly specified in the claims.

The electrical contacts of the standard USB device connector are functionally coupled with the electrical contacts of the proprietary device connector via an electrical communication channel. As used herein, “functionally coupled” means the contacts are associated in some way to perform a function. For example, in some instances the association may be physical (e.g., two electrical contacts directly or indirectly wired together or otherwise physically related within a circuit so as to perform a function).

In some embodiments, the communication channel includes three electrical lines that directly couple the corresponding D+, D−, and GND contacts on the standard USB device connector and proprietary device connector, as shown in FIG. 2. The lines may be optionally shielded from interference and noise. The lines can be made of any material and gage that is suitable for providing electrical communication (e.g., transmission of electrons, either for purposes of providing power or for transmitting data signals).

The communication channel also includes inline circuitry that is configured to (i) sense a characteristic of a signal originating from an electrical contact of the USB device connector and (ii) control a power direction based on the sensed characteristic. The inline circuitry can include a voltage switch and/or voltage regulator that functionally couples the VBUS electrical contacts on the standard and proprietary device connectors (e.g., Vin). The inline circuitry can also include a control and sense logic module that is configured change the state of the voltage switch and/or voltage regulator (e.g., on/off) based on a sensed characteristic originating from one or more electrical contacts on the USB device connector. The control and sense logic module is also configured to transmit data signals from one or more additional signal lines from additional electrical contacts on the proprietary device connector to the VBUS electrical contact on the standard USB device connector.

The cable described above can be used to establish electronic communication (e.g., power, data, etc) between two devices. In some embodiments, the first device is a handheld computing device that has a proprietary receptacle/port (e.g., an Apple® 30 pin port) and the second device is a peripheral device having a standard USB type B receptacle/port. For example, the cable described herein can be used to connect an Apple® iPad® (the handheld device) with a musical instrument digital interface (the peripheral device), such as Applicant's iConnectMIDI²⁺™, iConnectAUDIO⁴⁺™, iConnectAUDIO²⁺™, iConnectKeys™ and other peripheral devices using standard USB peripheral device connectors either licensed to or developed by, iKingdom Corp. IP and described at http://iconnectivity.com/Products. Like many peripheral devices, the iConnectMIDI^{2 +}™ is configured to receive power when connected to a desktop or laptop computer (power charge direction flows from the computer to the iConnectMIDI²⁺™). However, when the iPad® is connected to the iConnectMIDI²⁺™ using the cable described herein, the inline circuitry of the cable senses the iPad® (e.g., using a unique characteristic of the iPad such as a voltage) and permits the reverse power charging direction (e.g., changing the state of the voltage regulator). As such, the iConnectMIDI²⁺™ can provide a charging power signal to the iPad® while still allowing the iPad® to act as a master host for data communications. Those of ordinary skill in the art will appreciate that the inventive devices and methods described herein can be applied to other types of handheld computing devices and peripheral devices.

In sonic embodiments, the sensed characteristic is a voltage of a handheld device. The sense and control logic can be configured to switch the state of the voltage regulator when the sensed voltage is below a threshold voltage (e.g., 5 volts, 4 volts, 3 volts, etc). By switching the state of the voltage switch and/or voltage regulator, the power direction is reversed independently of the first and second differential data signals, thus allowing the handheld device to receive a power charging signal while still acting as a master host across a standard USB receptacle on a peripheral device.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

FIG. 1 is a schematic of a peripheral device that can be connected with either a desktop computer or a handheld computing device.

FIG. 2 is a schematic of a cable having an inline circuitry with sense and control logic.

FIG. 3 is one example of a decision tree for the sense and control logic of FIG. 2.

FIG. 4 is a state diaphragm for a voltage switch/regulator.

### DETAILED DESCRIPTION

Throughout the following discussion, numerous references will be made regarding servers, services, interfaces, portals, platforms, or other systems formed from computing devices. It should be appreciated that the use of such terms is deemed to represent one or more computing devices having at least one processor configured to execute software instructions stored on a computer readable tangible, non-transitory medium. For example, a server can include one or more computers operating as a web server, database server, or other type of computer server in a manner to fulfill described roles, responsibilities, or functions.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

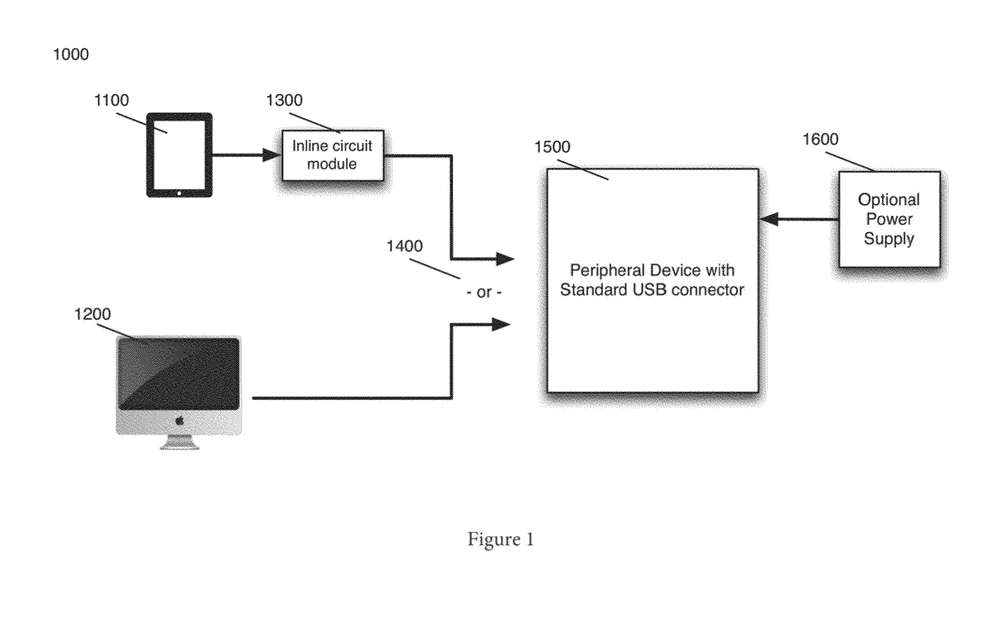

FIG. 1 shows a schematic 1000, illustrating how a peripheral device 1500 can be electrically coupled with either a desktop computer 1200 or a handheld computing device 1100. To electrically couple peripheral device 1500 with computer 1200, a standard USB cable is commonly used. The cable generally comprises a standard USB host connector (type A USB host connector) at one end that plugs into a standard type A USB receptacle/port on computer 1200. The other end of the cable is a proprietary device connector that plugs into a proprietary device receptacle/port on the peripheral device 1500. In this manner, a master-slave relationship is established between computer 1200 and device 1500 using USB standards and protocols. Under this relationship, computer 1200 is the master host and exclusively controls all data communications while providing peripheral device 1500 with a power signal for supplying power, when needed (e.g., when peripheral device is not plugged into optional power supply 1600).

As used herein, a “USB device connector” is a connector that is downstream relative to the standard USB power direction (e.g. receives a power charge) whereas a “USB host connector” is a connector that is upstream relative to the standard power direction (e.g., provides a power charge). For example, standard type A USB connectors are “upstream” (e.g., plugged into a computer) whereas a standard type B USB connector is downstream (e.g., plugged into a peripheral device) relative to power direction defined by the USB standard.

When peripheral device 1500 is connected to handheld device 1100, a different connection approach must be taken since handheld device 1100 does not have a standard USB host receptacle/port. Instead, handheld computing device 1100 has a proprietary connector that encompasses USB signaling plus other signaling. The inventive subject matter described herein provides a cable for establishing electrical communication between handheld device 1100 and peripheral device 1500 in a non-standard manner. More specifically, the cable includes an inline circuit module 1300 that is configured to sense a characteristic of handheld device 1100 and change the power direction so that peripheral device 1500 can supply a power signal to handheld device 1100, while still allowing handheld device 1100 to act as the master host for data communications.

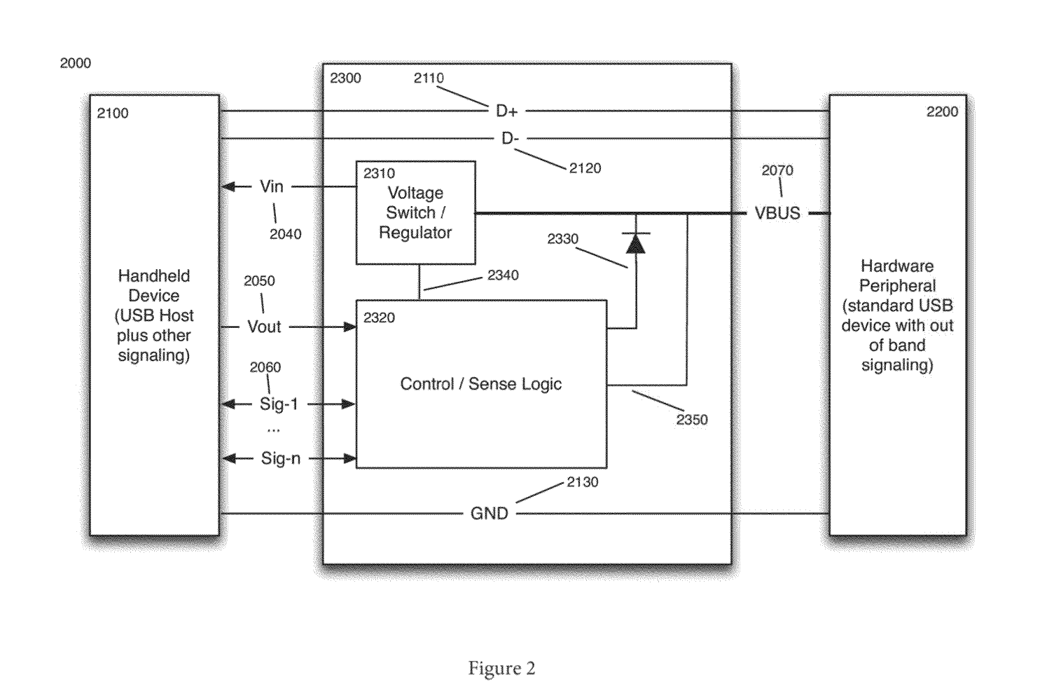

The inline circuit module 1300 is a control and sense logic board with power switching or regulation that manages multiple signals and power paths onto the standard (4-wire) USB device receptacle of peripheral device 1500. The inventive concepts of inline circuit module 1300 are further illustrated in FIG. 2.

FIG. 2 shows a schematic 2000, which represents a handheld device 2100 electrically coupled with a peripheral device 2200 via an inline circuitry 2300. Peripheral device 2200 has a standard USB device receptacle/port comprising four electrical contacts: two for supplying power (VBUS 2070 and GND 2130) and two for differential data signals (D+ 2110 and D− 2120). In the case of USB 3.0 (“SuperSpeed”), the USB device connector has five additional electrical contacts (two additional different pairs and one additional ground). Handheld device has a proprietary device receptacle/port with four corresponding electrical contacts (e.g., D+, D−, Vout 2050, and GND 2130). Handheld device 2100 also has a fifth electrical contact. Vin 2040, and additional contacts 2060 designated as additional data signal lines.

The corresponding electrical contacts designated as D+, D−, and GND on device 2100 and device 2200 are directly connected via the cable shown in FIG. 2. However, VBUS 2070 is indirectly coupled with Vin 2040 via voltage switch and/or voltage regulator 2310. VBUS 2070 is also electrically coupled with Vout 2050 and additional data signals 2060 via control and sense logic module 2320. Module 2320 is configured to sense a characteristic of a signal originating from an electrical contact of the USB device connector (coming from peripheral device 2200) and/or proprietary device connector (coming from handheld device 2100) (and from an electrical contact of the proprietary device connector). Module 2320 is also capable of controlling the state of switch/regulator 2310 as a function of the sensed characteristic, to thereby switch the direction of power flowing through VBUS 2070 and Yin 2040.

Inline circuit module 2300 thus enables power management and data signaling to occur while utilizing standard USB signaling at the peripheral device 2200, permitting the use of standard USB connectors. In the case of FIG. 2, handheld device 2100 has limited power capability (e.g., handheld device 2100 is currently running on a battery). For standard USB connections, generally the peripheral device power on the VBUS 2070 line not only powers the peripheral device 2200 but also starts the USB communication process. The combination of the Control/Sense Logic 2320 along with a voltage switch or switchable regulator 2310 provides back power from VBUS 2070 of the peripheral device 2200 at the appropriate time (e.g., when handheld device 2100 is connected and initialized) and thus switch the power direction from the peripheral hardware 2200 to the handheld device 2100. Although this is not a standard use of USB connectivity, this method provides a safe way to reverse power direction of VBUS 2070 from the peripheral device 2200 to a host (e.g., handheld device 2100).

In addition, the various loading and power direction states are monitored by the control/sense logic 2320 and the states then translate into not only enabling the voltage switch/regulator 2310 but also, if needed, the management of the additional signaling lines 2060. Some examples include management of various handheld states like accessory detect, peripheral identity, and others.

In the embodiment described above handheld device 2100 acts as a USB host while peripheral device 2200 acts as a USB device. However, the inventive principles disclosed herein could be utilized in the other direction, wherein, device 2100 acts as a USB device and the peripheral device 2200 acts as a USB host. In this case, the handheld would be operating as the USB slave to the USB master (e.g., the peripheral device), but would require additional signaling (e.g., signals 2050, 2060) for its operation. For example, when the peripheral device is the iConnectivity⁴⁺™, the handheld device (e.g., Windows® or Google® device) could connect to the USB host receptacle on the iConnectivity⁴⁺™. As such, the handheld device would act as the slave to the iConnectivity⁴⁺™ with extra signaling,

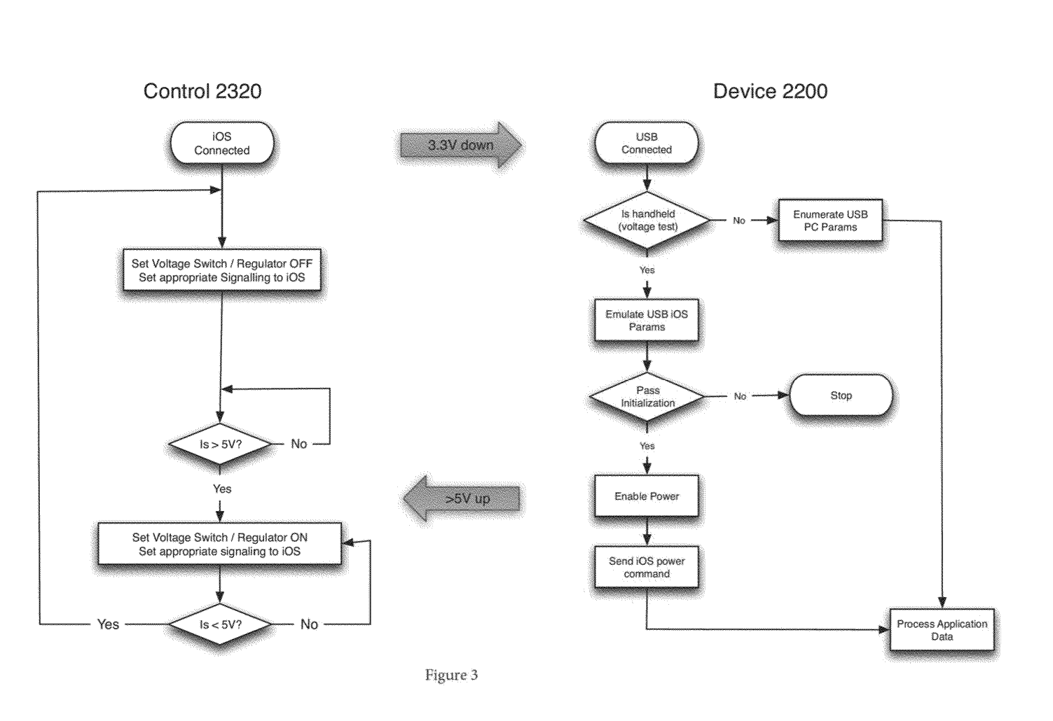

FIG. 3 shows one possible embodiment for two simultaneous state management decision trees (performed by control and sense logic 2320 and peripheral device 2200), when handheld device 2100 is plugged into a peripheral device 2200. In this particular example, handheld device 2100 comprises an Apple® device running iOS®. When device 2100 is first plugged into device 2200 using the cable previously described, a power flows from device 2100 and from control and sense logic module 2320 to the USB device receptacle of device 2200, as shown by the top arrow pointing left to right. Voltage switch/regulator 2310 starts in the OFF state and with appropriate signaling to iOS. Device 2200 identifies a characteristic of a signal originating from device 2100 to determine a type of device and to decide on a power state. In this case, the characteristic is a voltage (e.g., 3.3V) of handheld device 2100. If device 2200 detects handheld device 2100 as a PC device, it enumerates USB PC parameters and then proceeds to process application data. If device 2200 detects handheld device 2100 as an iOS device, device 2200 emulates USB iOS parameters and begins initialization, if the initialization is passed, device 2200 enables power and sends power to control 2320, as shown by the bottom arrow pointing right to left. When control 2320 detects a >5V, it then sets voltage switch/regulator 2310 to ON and sets appropriate signaling to iOS to allow for charging. Control 2320 continues to monitor a signal (e.g., voltage of the power signal) from an electrical contact on its USB device connector and when a certain characteristic is determined (e.g., less than 5V), changes the state of voltage switch/regulator 2310 back to OFF.

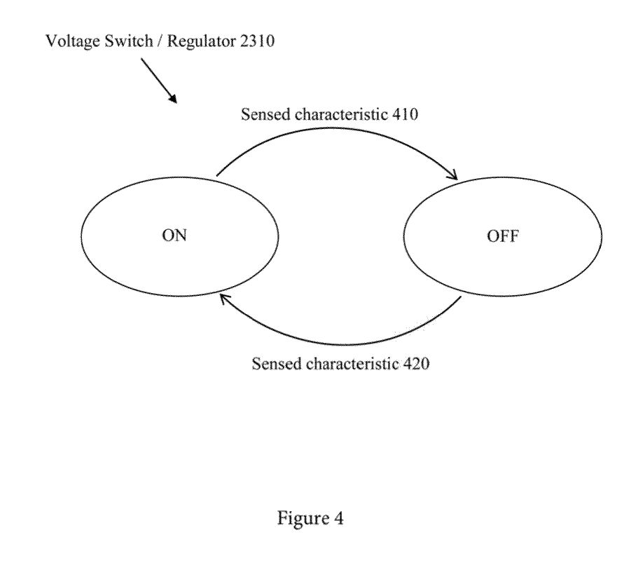

FIG. 4 shows a state diagram of voltage switch/regulator 2310. Control 2320 controls the state of voltage switch/regulator 2310 as a function of sensed characteristics 410 (e.g., >5V) and 420 (e.g., <5V).

In some embodiments control sense logic 2320 consists essentially of analog components. The analog components could comprise a logic board capable of performing the primary functions of (i) sensing a signal characteristic from the handheld device 2100 and the peripheral device 2200 and controlling voltage regulator 2310. In yet other embodiments, control sense logic 2320 could include a combination of analog and digital components (processor chips, firmware) that perform the necessary functions.

The inventive subject matter also comprises a peripheral device having a USB device receptacle that can be connected with a host device (e.g., PC, laptop, tablet, phone, etc). The peripheral device is configured to identify a characteristic of a signal originating from one of the electrical contacts on the USB device receptacle. The characteristic is unique to a type of host device (e.g., handheld vs. PC, iOS vs. Windows vs. Andriod, etc). The peripheral device is also configured to enumerate a set of USB parameters that are specific to the type of host device represented by the characteristic (e.g., PC vs. iOS) and send power to an electrical contact of the USB device receptacle when the type of host device is a handheld device (e.g., iOS, Andriod).

In some embodiments, the sensed characteristic is a voltage. For example, when the peripheral device senses a voltage of less than 5V it can determine the type of host device (e.g., iOS) and send a power command or power signal to the host device.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

The recitation of ranges of values herein is merely intended to serve as a shorthand method of referring individually to each separate value falling within the range. Unless otherwise indicated, herein, each individual value with a range is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention,

Groupings of alternative elements or embodiments of the invention disclosed herein are not to be construed as limitations. Each group member can be referred to and claimed individually or in any combination with other members of the group or other elements found herein. One or more members of a group can be included in, or deleted, from, a group for reasons of convenience and/or patentability. When any such inclusion or deletion occurs, the specification is herein deemed to contain the group as modified thus fulfilling the written description of all Markush groups used in the appended claims.

As used herein, and unless the context dictates otherwise, the term “coupled to” is intended to include both direct coupling (in which two elements that are coupled to each other contact each other) and indirect coupling (in which at least one additional element is located between the two elements). Therefore, the terms “coupled to” and “coupled with” are used synonymously.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

1. A cable for establishing electronic communication between a first device and a second device comprising:
a first end comprising a standard USB device connector having a first electrical contact, a second electrical contact, a third electrical contact, and a fourth electrical contact;
a second end comprising a proprietary device connector having a first electrical contact, a second electrical contact, a third electrical contact, and a fourth electrical contact;
an electrical communication channel functionally coupling the first through fourth contacts of the standard USB device connector with the first through fourth contacts of the proprietary device connector; and
an inline circuitry disposed in the communication channel and configured to control a power direction based on a characteristic of a signal originating from an electrical contact of the USB device connector.

2. The cable of claim 1, wherein the standard USB device connector is a standard type B USB connector.

3. The cable of claim 2, wherein the proprietary device connector is selected from the group consisting of an Apple® 30 pin dock connector, an Apple® lightning connector, a PDMI connector, and a Samsung® 30 pin connector.

4. The cable of claim 3, wherein the electrical communication channel includes a first electrical line directly coupling the first electrical contact on the first end with the first electrical contact on the second end.

5. The cable of claim 4, wherein the electrical communication channel includes a second electrical line directly coupling the second electrical contact on the first end with the second electrical contact on the second end.

6. The cable of claim 5, wherein the electrical communication channel includes a third electrical line directly coupling the fourth electrical contact on the first end with the fourth electrical contact on the second end.

7. The cable of claim 6, wherein the first electrical contacts and the second electrical contacts on the first end and second end are designated as first differential data signals and second differential data signals, respectively.

8. The cable of claim 7, wherein the third electrical contacts on the first end and second end are designated as a power voltage signal.

9. The cable of claim 8, wherein the fourth electrical contacts on the first end and second end are designated as a ground signal.

10. The cable of claim 9, wherein the inline circuitry comprises:
a fourth electrical line coupling the third electrical connectors
a voltage regulator disposed in the fourth electrical line;
a sense and control logic configured to (i) sense the characteristic and (ii) control the state of the voltage regulator as a function of the characteristic.

11. The cable of claim 10, wherein the characteristic is a voltage.

12. The cable of claim 11, wherein the sense and control logic is configured to switch the state of the voltage regulator when the characteristic is below a threshold voltage.

13. The cable of claim 12, wherein the threshold voltage is 5 Volts.

14. The cable of claim 9, wherein the inline circuitry is configured to control the power direction independently of the first and second differential data signals.

15. The cable of claim 1, wherein the proprietary device connector has a fifth electrical contact.

16. The cable of claim 15, wherein the third electrical contact on the second end is designated as a voltage-in and the fifth electrical contact on the second end is designated as a voltage-out.

17. The cable of claim 16, further comprising sixth through n^{th} electrical contacts on the second end, the sixth through nth electrical contacts being designates as additional signaling lines.

18. A communications system comprising:
a handheld computing device having a proprietary receptacle;
a peripheral device having a standard USB device receptacle; and
the cable of claim 1, wherein the proprietary connector is compatible with the proprietary receptacle of the handheld computing device.

19. The communications system of claim 18, wherein the peripheral device is a MIDI interface.

20. The communications system of claim 19, wherein the MIDI interface is selected from the group consisting of iConnectMIDI²⁺™, iConnectMIDI⁴⁺™, iConnectAUDIO⁴⁺™, iConnectAUDIO²⁺™, and iConnectKeys™.

21. The communications system of claim 18, wherein the inline circuitry of the cable is configured to establish the power direction as flowing from the peripheral device to the handheld computing device.

22. The communications system of claim 18, wherein the peripheral device is capable of detecting a voltage of the handheld computing device and supplying power to the handheld computing device.

23. A peripheral device having a USB device receptacle for electrically coupling with a host device, the peripheral device being configured to:
identify a characteristic of a signal originating from a first electrical contact of the USB device receptacle, wherein the characteristic is unique to a type of host device;
enumerate a set of USB parameters that are specific to the type of host device represented by the characteristic;
send power to the first electrical contact of the USB device receptacle when the type of host device is a handheld device.

24. The peripheral device of claim 23, wherein the characteristic is a voltage of less than 5V.

25. The peripheral device of claim 23, wherein the type of host device is one of a PC device and an iOS device.

26. The peripheral device of claim 23, wherein the type of host device is defined by an operating system type.
